(19) United States
(12) Patent Application Publication
(10) Pub. No.: US 2018/0169914 A1
(43) Pub. Date: Jun. 21, 2018

(54) METHOD OF FORMING A SURFACE COVERING, AND APPARATUS AND COMPOSITION FOR FORMING A SURFACE COVERING

(71) Applicants: Martin BALL, Shropshire (GB); Christian RYMER, Shropshire (GB)

(72) Inventors: Martin BALL, Shropshire (GB); Christian RYMER, Shropshire (GB)

(73) Assignee: Ricoh Company, Ltd., Tokyo (JP)

(21) Appl. No.: 15/840,341

(22) Filed: Dec. 13, 2017

(30) Foreign Application Priority Data
Dec. 15, 2016 (EP) 16204467.1
Dec. 11, 2017 (EP) 17206541.9

(51) Int. Cl. B29C 44/12; D06N 7/00; C08J 9/10; C08J 9/00

(52) U.S. Cl. CPC B29C 44/12; D06N 7/0002; D06N 7/0015; B29K 2027/06; C08J 9/0023; C08J 9/101; C08J 9/103

(57) ABSTRACT

A method of forming a surface covering includes supplying a surface covering raw material. The surface covering raw material includes a substrate and a foamable layer formed on the substrate. A foaming inhibiting composition is applied in a predetermined pattern to the foamable layer formed on the substrate. The foaming inhibiting composition is a non-aqueous composition.

### CROSS-REFERENCE TO RELATED APPLICATIONS

The present application claims priority under 35 U.S.C. § 119 to European Patent Applications No. 16204467.1, filed on Dec. 15, 2016, and Ser. No. 17/206,541.9, filed on Dec. 11, 2017, the contents of each of which are incorporated herein by reference in their entirety.

### BACKGROUND OF THE INVENTION

### 1. Field of the Invention

The present invention relates to a method of forming a surface covering such as wallpaper or a floor covering, and an apparatus and a composition for forming a surface covering.

### 2. Description of the Related Art

Wallpaper is widely used in buildings to give a desirable finish and appearance to walls. Similarly, floor coverings formed of sheet-like material can be similarly used to provide floor surfaces with a desired finish and appearance. These surface coverings typically include a sheet-like substrate to provide strength and to define a suitable surface for adhering to a surface such as a wall or floor. The surface covering also includes a surface layer formed of resin, which provides scratch and stain resistance and also affects the appearance of the surface covering. Typically, the resin layer includes a polyvinyl chloride-based resin containing an ester-oil-based plasticizer and a foaming agent. As part of the manufacturing process of the surface covering, a foaming agent is used to foam the resin layer to enable the surface covering to be expanded and embossed for decorative effect. The resin layer has depth and three-dimensional decoration can be formed in the resin layer. Conventionally, this is achieved by mechanical embossing means. For example, an embossing roller with the negative of the desired three-dimensional surface pattern formed on its surface is used to impress the desired pattern on the resin layer. However, mechanical embossing lacks flexibility, as the roller can only be used to form one pattern.

For this reason, attempts have been made to form the desired three-dimensional decoration by chemical means. In particular, systems have been proposed in which a foaming inhibitor is applied in a predetermined pattern to the surface of the resin. The foaming inhibitor may operate, for example, by deactivating a foaming accelerator which is included in the foaming resin composition. In a subsequent step, when foaming of the resin layer takes place, the extent of foaming of a region of the surface will depend on the amount of foaming inhibitor which has been applied thereto. In this way, a three-dimensional surface pattern can be formed in the resin layer.

As the foaming inhibitor can be applied by a digitally controllable device in a known manner, which is controllable by conventional image processing equipment, the three-dimensional pattern formed on the surface covering can be changed very flexibly by controlling the operation of the printing.

WO 2013/050815 discloses a method for producing a wall covering (such as wallpaper) in which a liquid which influences the expansion of expandable material in a wall covering is applied in a desired pattern using a digital printing technique, for example inkjet printing. The liquid which influences the expansion of expandable material may be as described in U.S. Pat. No. 5,712,018. U.S. Pat. No. 5,712,018 discloses a water-based embossing composition for use in chemically embossing a foamable polymeric material, for example a textured floor covering, which includes a modifier for modifying the activity of a blowing agent in the resin layer. Typically, the modifier includes a triazole, preferably benzotriazole or tolyltriazole. US 2008/0092773 discloses a recording ink including a color material particle, a polymer particle, a water-soluble solvent and water, which may be used in an inkjet recording apparatus.

### SUMMARY OF THE INVENTION

According to an aspect of the present invention, a method of forming a surface covering includes supplying a surface covering raw material. The surface covering raw material includes a substrate and a foamable layer formed on the substrate. A foaming inhibiting composition is applied in a predetermined pattern to the foamable layer formed on the substrate. The foaming inhibiting composition is a non-aqueous composition.

### BRIEF DESCRIPTION OF THE DRAWINGS

Other objects, features and advantages of the present invention will become more apparent from the following detailed description when read in conjunction with the accompanying drawings, in which:

FIG. 1 is a schematic view of an apparatus for forming a surface covering according to an embodiment of the present invention;

FIG. 2 is a schematic diagram illustrating a finished surface covering according to an embodiment of the present invention; and

FIG. 3 is a flowchart illustrating a method of forming a surface covering according to an embodiment of the present invention.

### DESCRIPTION OF THE EMBODIMENTS

The present inventors have discovered that the use of a water-based embossing composition over a long period in an inkjet printer leads to problems of clogging of the inkjet printing head, with the attendant problems of poor quality pattern formation or even interruption of the printing process.

The present inventors have invented the use of a non-aqueous foaming inhibiting composition in an inkjet process during the formation of a surface covering over a long period, which leads to reduction in clogging of the inkjet printing head.

According to an aspect of the present application, a method of forming a surface covering, an apparatus for forming a surface covering, and a composition for forming a surface covering which can be used to provide high-quality three-dimensional pattern reproduction over a long period in an inkjet based system are provided.

Optional and preferred features according to embodiments of the present invention will be described further below with reference to the accompanying drawings.

First, an apparatus for forming a surface covering according to an embodiment of the present invention is described.

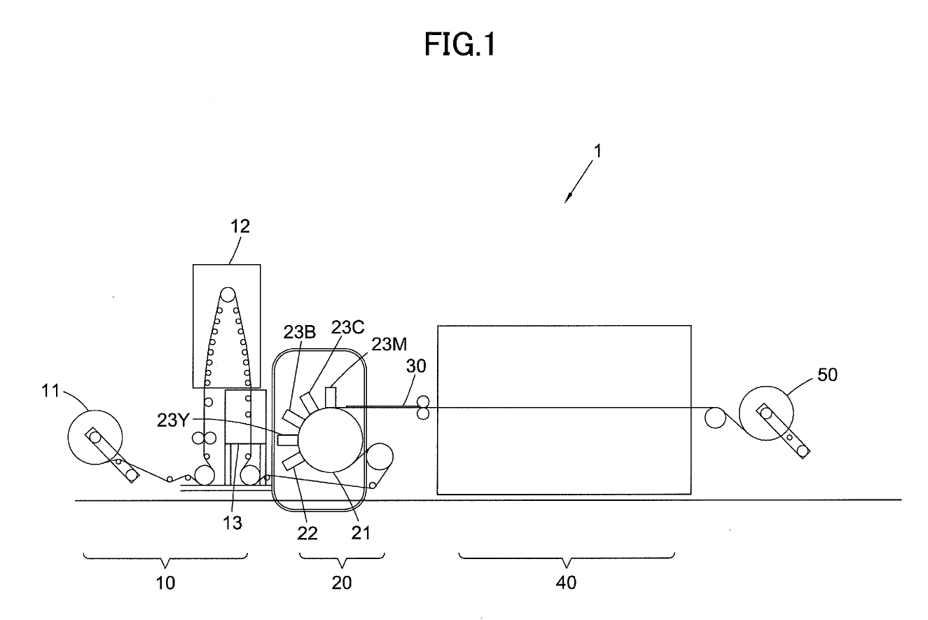

FIG. 1 illustrates an apparatus 1 for forming a surface covering (“apparatus 1”) according to an embodiment of the present invention. The apparatus 1 includes a supply unit 10 configured to supply surface covering raw material. The supply unit 10 preferably includes an unwinder roller 11 or any other suitable apparatus, a screen coater 12 (foamable layer coater), and a preheater 13. The unwinder roller 11 is configured to supply a continuous sheet of sheet-like substrate (“substrate”). The substrate is fed to the screen coater 12, in which a foamable layer is formed on the substrate to form a surface covering raw material. The preheater 13 is configured to heat the surface covering raw material to a temperature of, for example, less than 150° C. to gel resin in the foamable layer.

In a preferred embodiment, the surface covering raw material is fed as a continuous sheet. The apparatus 1 further includes an applicator configured to apply a foaming inhibiting composition in a predetermined pattern to the foamable layer formed on the substrate, such as an inkjet printing station 20. The inkjet printing station 20 preferably includes a drum 21. Preferably, the drum 21 is of relatively large diameter, being preferably in the range of 0.1 meters to 2 meters, more preferably 0.5 meters to 1.5 meters and preferably about 1 meter in diameter. The axis of rotation of the drum 21 is orientated at right angles to the direction of feed of the sheet-like surface covering raw material (the surface covering raw material in sheet form) (“feed direction”), so that the sheet-like surface covering raw material is wound around the drum 21.

The inkjet printing station 20 further includes a foaming inhibiting composition applying inkjet printing head 22 (“inkjet printing head 22”) configured to apply a foaming inhibiting composition according to an embodiment of the present invention to the surface covering raw material. The inkjet printing head 22 may be heatable to control the viscosity of the foaming inhibiting composition. For example it may be heatable to a temperature in the range of 30° C. to 60° C., most preferably around 45° C.

The inkjet printing station 20 may further include a yellow color inkjet printing head 23Y, a black color inkjet printing head 23B, a cyan color inkjet printing head 23C, and a magenta color inkjet printing head 23M. The inkjet printing heads 22, 23Y, 23B, 23C and 23M are arranged in sequence around the drum 21 in order in the feed direction. At least one inkjet printing head is mounted adjacent to the drum 21 for applying the foaming inhibiting composition to the surface covering raw material while the surface covering raw material is on the outer peripheral surface of the drum 21. Preferably, the feed speed of the surface covering raw material is 70 meters per minute.

In an alternative embodiment, the inkjet printing station 20 may include multiple drums, at least one inkjet printing head being mounted adjacent to at least one drum. The drums are preferably mounted with their axes parallel. Preferably, the axes lie on a curved surface, so that the surface covering raw material can be tensioned around the drums.

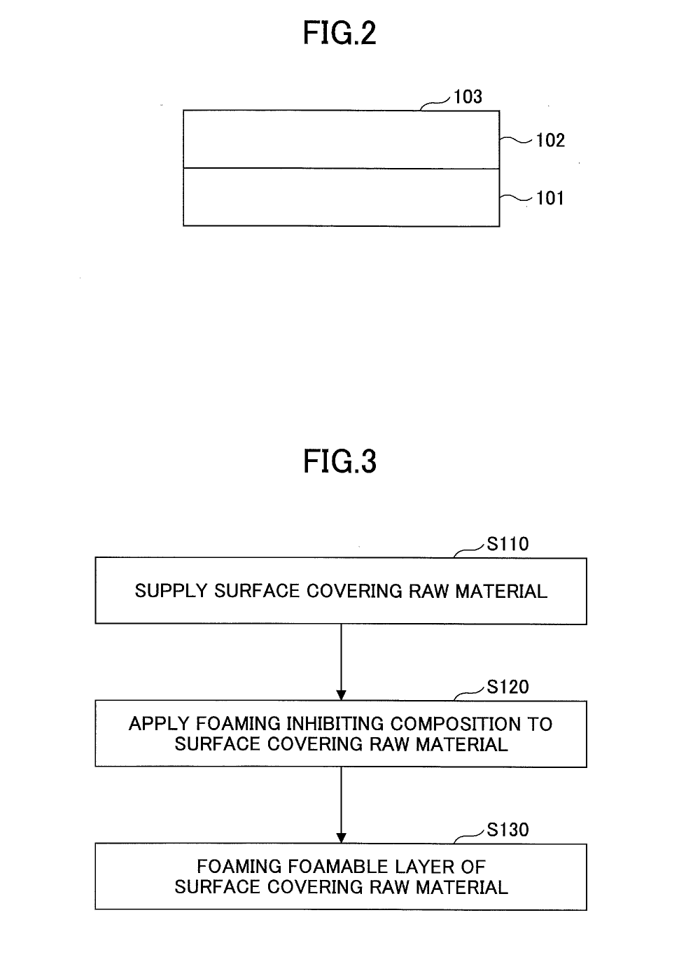

The apparatus 1 may further include a coating station 30 including a screen coater configured to apply a surface finish to the surface covering raw material. The apparatus 1 may further include a foaming apparatus 40 in which the surface covering raw material is heated to a temperature in the range of 150° C. to 250° C., preferably, 180° C. to 220° C., and most preferably, about 200° C. so that the foamable layer foams, at least in parts where the foaming inhibiting composition has not been applied, so that a three-dimensional textured surface 103 (FIG. 2) is obtained. Finally, the finished surface covering (textured surface covering) is wound onto a roller rewinder 50 for storage and further transportation. The coating station 30 may be located either upstream or downstream of the foaming apparatus 40 in the feed direction.

According to an embodiment of the present invention, the foaming inhibiting composition applied to the surface covering raw material is a non-aqueous foaming inhibiting composition.

By the term “non-aqueous,” it is meant that water is not used as a solvent. Preferably, the content of water in the foaming inhibiting composition is less than 1% by weight, more preferably less than 0.1% by weight. The composition of the foaming inhibiting composition will be described in detail further below.

The surface covering to be produced by an embodiment of the present invention may include any suitable surface covering, but is preferably wallpaper or a floor covering material. FIG. 2 is a schematic diagram illustrating a finished surface covering according to an embodiment of the present invention. Referring to FIG. 2, the surface covering includes a substrate 101 and a foamed layer 102 formed on the substrate 101. The foamed layer 102 is obtainable by foaming the foamable layer of the surface covering raw material.

The substrate 101 may be any conventional substrate. Typically, the substrate 101 is a flat substrate, for example a flat sheet-like material. The substrate 101 may be formed of paper, non-woven fabric or combinations of these materials. Specific examples of materials may be selected from natural paper, plastic film, synthetic paper, non-woven fabric, fleece, cloth, wood and metal thin film or any combination of these materials. In a preferred embodiment, the substrate 101 includes fleece-backed paper.

The substrate 101 is preferably selected from a plastic film, a synthetic paper sheet made of a synthetic fiber, or a non-woven fabric sheet if water resistance is required. Specific examples of the plastic film include, but are not limited to, a polyester film, a polypropylene film, a polyethylene film, and a laminated body of nylon, vinylon, and/or acrylic films or sheets. The plastic film is preferably subjected to uniaxial to biaxial drawing for improving its strength. Specific examples of the non-woven fabric sheet include a sheet formed by spreading polyethylene fibers in a sheet-like pattern and bonding the polyethylene fibers by heat and pressure.

Next, a method of forming a surface covering according to an embodiment of the present invention is described with reference to FIG. 3. FIG. 3 is a flowchart illustrating a method of forming a surface covering according to an embodiment of the present invention.

In a preferred embodiment of the method of forming a surface covering, at step S110, a surface covering raw material is supplied using, for example, the supply unit 10. The step of supplying a surface covering raw material includes a first step of supplying a substrate using, for example, the unwinder roller 11 and a second step of applying a foamable layer to the substrate by, for example, screen coating, using a foamable layer coater such as the screen coater 12. The method for applying the foamable layer to the substrate is not limited to screen coating, and any other suitable method may be used.

In an alternative embodiment, the surface covering raw material is prepared separately. The supplying step may therefore simply include feeding the surface covering raw material, for example, using an unwinder roller.

The surface covering raw material including the substrate and the foamable layer may be heat treated so that the foamable layer forms a “gel” state. The heat treatment temperature should be below a temperature at which the foamable layer foams, in order to avoid premature foaming of the foamable layer.

The heat treatment may be provided as an optional step in the method of the illustrated embodiment or it may be applied to the surface covering raw material before it is supplied in the method of the illustrated embodiment.

Next, at step S120, a foaming inhibiting composition is applied in a predetermined pattern to the surface covering raw material by an inkjet printing method.

Any suitable inkjet printing apparatus and method may be used to apply a foaming inhibiting composition. The inkjet printing station 20 is an example of an inkjet printing apparatus. Furthermore, for example, the print head from a RICOH Pro 4130 (trademark) wide format latex color printer may be used as the inkjet printing head 22.

The surface covering raw material may be heated while the foaming inhibiting composition is applied. It may be heated to a temperature in the range up to 150° C., preferably in the range 100° C. to 150° C.

Heating the surface covering raw material can assist penetration of the foaming inhibiting composition into the foaming layer and thereby enhance the foaming inhibiting effect. However, the surface covering raw material should preferably not be heated to a temperature which is greater than or equal to a temperature at which foaming occurs in order to prevent premature foaming of the foamable layer.

The foaming inhibiting composition includes a foaming inhibiting material. The foaming inhibiting material is one which is effective to inhibit foaming of the foamable layer. The composition of the foaming inhibiting material will depend upon the foamable layer used. For example, the foaming inhibiting material may be as specified in U.S. Pat. No. 5,712,018.

Preferably, the foamable layer includes a resin material and a foaming agent. The foamable layer (resin layer) may also include optional components selected from a plasticizer, a foaming accelerator, a filler, a dispersant, a defoamer, an antiblocking agent, and a thickener. Suitable compositions are disclosed for example in U.S. Pat. No. 3,321,413.

The resin material may be any suitable resin, but is preferably vinyl resin, acrylic resin or acrylic resin copolymer, preferably vinyl resin and most preferably polyvinylchloride. Polyvinyl chloride is preferably used because of its good chemical and physical properties and low cost.

The foamable layer is preferably applied as a liquid composition which includes a mixture of the resin material and the plasticizer and, optionally other components as set out above. It may be obtained commercially, for example under the trade mark PS1652 Expandable PVC Plastisol. The mixture may be in any suitable form, for example an emulsion or a suspension of particulate solid material in a liquid. In a preferred embodiment, the liquid composition includes the resin in powder form dispersed in a liquid plasticizer.

Preferably, the resin is present in the plasticizer in an amount of 100 parts by weight of resin to 30-100 parts by weight of plasticizer.

Specific examples of the filler include, but are not limited to, aluminium hydroxide, magnesium hydroxide, barium hydroxide, calcium carbonate, magnesium carbonate, calcium sulphate, barium sulphate, ferrous hydroxide, basic zinc carbonate, basic lead carbonate, silica sand, clay, talc, silica, titanium dioxide and magnesium silicate. Among these materials, calcium carbonate, magnesium carbonate, aluminium hydroxide, and magnesium hydroxide are preferred.

Preferably, the foamable layer includes PVC. In the present specification, PVC means polymerizing vinyl chloride.

Specific examples of the plasticizer include, but are not limited to, phthalate-based plasticizers such as dibutyl phthalate, dinonyl phthalate (DNP), dioctyl phthalate (DOP), dodecyl phthalate (DDP), diisodecyl phthalate (DIDP), diisononyl phthalate (DINP), ditridecyl phthalate (DTDP), and n-hexyl-n-decyl phthalate (NHDP); phosphate based plasticizers such as tri-2-ethylhexyl phosphate (TOP); adipate-based plasticizers such as didecyl adipate (DDA) and diisodecyl adipate (DIDA); trimellitate-based plasticizers such as trioctyl trimellitate (TOTM), and tri-n-octyl-n-decyl trimellitate (nonyl DTM); polyester based plasticizers; epoxy-based plasticizers; sebacate-based plasticizers; azelate-based plasticizers; citrate based plasticizers; glycolate-based plasticizers; ricinolate-based plasticizers; maleate-based plasticizers; fumarate-based plasticizers; pyromellitate-based plasticizers, benzoate plasticizers and itaconate-based plasticizers. Preferably, diisononyl phthalate (DINP) is used.

The purpose of the foaming agent is to produce a foamed effect in the surface covering. Suitably, the foaming agent is adapted to produce a foamed effect in the surface covering when heated, for example when heated to a foaming temperature which may be in the range of 200° C. to 210° C. The foaming agent may be an inorganic foaming agent or an organic foaming agent. Specific examples of the organic foaming agent include, but are not limited to, azodicarbonamide (ADCA), azobisisobutyronitrile (AIBN), p,p′-oxybisbenzenesulfonohydrazide (OBSH) and dinitrosopentamethylenetetramine (DPT). Preferably azodicarbonamide is used.

The purpose of the accelerator is to reduce the temperature at which the foaming effect occurs. For example, with accelerator the foaming effect may occur at a lower foaming temperature which may be in the range of 150° C. to 160° C. The accelerator may be selected from compounds of cadmium, lead and zinc such as stearates, octoates, naphthenates and benzoates, which lower the decomposition temperatures of azodicarbonamide.

The foaming inhibiting composition may operate by any suitable route. For example, it may operate so as to inhibit the foaming reaction itself, so that the foaming reaction will not occur at the foaming temperature or lower foaming temperature. Suitable inhibitors for inhibiting the foaming reaction are disclosed in U.S. Pat. No. 3,293,094.

Alternatively, the foaming inhibitor may operate by inhibiting the action of the accelerator. In particular, preferably, the foaming inhibitor inhibits the accelerator so that foaming does not occur at the lower foaming temperature. For example, if the foaming temperature is in the range of 150° C. to 160° C., the foaming inhibitor may prevent operation of the accelerator in this temperature range.

The foaming inhibitor that operates by deactivating a foaming accelerator is suitably selected from benzotriazole derivatives, tolutriazole derivatives, N,N′-Diphenyloxamide, N,N-dibezoylhydrazine, N-Salicylal-N′(salicyloyl)hydrazide, N,N′-Bis(salicyloyl)hydrazide, N,N′-Bis(3,5-di-tert-butyl-4-hydroxyphenylpropionyl)hydrazine, 3-N-Salicyloylamino-1,2,4-triazole, decamethylene dicarboxylic acid-bis(N′-salicyloylhydrazide), bis(benzylidene)oxalyl dihydrazide and oxanilide. Preferably, it is selected from benzotriazole derivatives and tolutriazole derivatives, for example, N,N-bis (2-ethylhexyl)-4-methyl-1H-benzotriazole-1-methylamine.

The foaming inhibiting composition used in the method and apparatus of the illustrated embodiments include a foaming inhibitor and may suitably include other components selected from a diluent such as a plasticizer or an oily component and a colorant. Preferably, the foaming inhibiting composition includes less than 1% by weight and most preferably less than 0.1% by weight of a solvent such as a volatile organic compound (VOC) solvent. The foaming inhibiting composition of the illustrated embodiments includes a foaming inhibitor and includes less than 1% by weight and more preferably less than 0.1% by weight of a VOC solvent. A VOC solvent is preferably as defined by the EU Directive 1999/13/EC (Solvent Emissions Directive), an organic compound having at 293.15 K a vapor pressure of 0.01 kPa or more. It is desired to reduce the amount of a VOC solvent used for environmental and health reasons. The inventors have discovered that compositions can be produced which are non-aqueous and which have little or no VOC solvent and which can be used in the method of the illustrated embodiment.

It is particularly preferred that at least part of the plasticizer should be the same as a plasticizer, or compatible with the plasticizer, which is present in the foamable layer of the surface covering raw material. This is found to enhance penetration of the foaming inhibiting material into the foamable layer which improves the foaming inhibiting effect. Preferably, at least 30% by weight of the plasticizer is the same as a plasticizer which is present in the foamable layer of the surface covering raw material, more preferably at least 50% by weight and most preferably over 75% by weight.

The viscosity of the diluent is preferably in the range from 5 mPas to 30 mPas, more preferably from 8 mPas to 18 mPas, most preferably from 10 mPas to 12 mPas at 45° C. Viscosity is preferably measured using a Brookfield DV-III Ultra Programmable Rheometer. Specific examples of the plasticizer or oily component which may be used as the diluent include phthalic acid esters such as dibutyl phthalate, dioctyl phthalate (DOP); adipic acid esters such as dioctyl adipate (diethylhexyl adipate; DOA) and diisononyl adipate (DINA); and citric acid esters, such as acetyl tributyl citrate (ATBC). Preferably, dioctyl adipate is used.

The composition will preferably be colorless (that is, not including any colorant) but could also include colorants. Specific examples of colorants include, but are not limited to, carbon black, pigments such as azo pigments, phthalocyanine pigments, nitroso pigments, nitro pigments, vat-dye pigments, mordant dye pigments, basic-dye pigments, acid dye pigments and natural-dye pigments; and oil soluble dyes such as diazo dyes and anthraquinone dyes.

The content of the foaming inhibiting material in the foaming inhibiting composition is preferably in the range from 5% by weight to 100% by weight. If the content is less than 5% by weight, the foaming inhibiting effect is likely to be insufficient. Preferably, the content of the foaming inhibiting material is in the range from 5% to 70%, more preferably from 20% to 50%. By reducing the quantity of the foaming inhibiting material, the viscosity may be reduced. Preferably, the quantity of the diluent is in the range of 0% by weight to 95% by weight, preferably 30% by weight to 95% by weight, more preferably 50% by weight to 80% by weight. Increasing the diluent such as a plasticizer or oily component can decrease the viscosity.

The viscosity of the foaming inhibiting composition is preferably in the range from 5 mPas to 30 mPas, more preferably from 8 mPas to 18 mPas, most preferably from 10 mPas to 12 mPas at 45° C. Viscosity is preferably measured using a Brookfield DV-III Ultra Programmable Rheometer.

Additionally, a visible pattern may be formed on the optional surface covering raw material as part of the process of the illustrated embodiment, or in the apparatus of the illustrated embodiment. An image may be formed by any suitable means, for example photogravure printing, but preferably an image is applied by inkjet printing. For example, full color inkjet printing may be used. Conventional yellow, black, cyan, and magenta printing heads such as the printing heads 23Y, 23B, 23C and 23M may be used. In the embodiment in which the surface covering raw material is fed around a drum, at least one inkjet printing head for forming a visible image is preferably mounted adjacent to the drum.

Preferably, the inkjet printing head 22 is located upstream of the at least one visible image inkjet printing head. This is found to give improved image density than if the visible image is applied before the foaming inhibiting composition.

Referring to FIG. 3, the method of the illustrated embodiment preferably further includes the step of foaming the foamable layer after application of the foaming inhibiting composition, using, for example, the foaming apparatus 40 (step S130). Any conventional foaming apparatus may be used. Suitably, foaming is achieved by heating the foamable layer. Preferably, the foamable layer is heated to a temperature in the range of 150° C. to 250° C., preferably 180° C. to 220° C. and most preferably about 200° C.

Optionally, the method of the illustrated embodiment further includes a coating step, for applying a suitable coating material to the surface covering raw material before foaming or after foaming, to provide an additional level of surface protection.

Next, examples according to the illustrated embodiments are described.

### Example 1

The apparatus 1 of the above-described embodiment was used to provide wallpaper.

The wall included paper having a fleece backing. A foamable layer composition was applied to the fleece-backed paper.

A foaming inhibiting composition including 50% by weight of tolyltriazole (CUVAN 303 (trade mark) obtainable from Vanderbilt Chemicals) and 50% by weight of dioctyl adipate obtainable from Brenntag AG was applied in a pattern by the inkjet printing head 22 to the surface covering raw material and the surface covering raw material was subsequently foamed. The resulting surface covering showed a clear three-dimensional pattern obtainable on the surface corresponding to the deposition pattern of the foaming inhibiting material applied by the inkjet printing head 22.

### Example 2

Except for using acetyl tributyl citrate (ATBC) instead of dioctyl adipate as a diluent, a foaming inhibiting composition was prepared and applied to the surface covering raw material by the inkjet printing head 22, and the surface covering raw material was thereafter foamed the same as in Example 1. The resulting surface covering showed a clear three-dimensional pattern obtainable on the surface corresponding to the deposition pattern of the foaming inhibiting material applied by the inkjet printing head 22.

All examples and conditional language provided herein are intended for pedagogical purposes of aiding the reader in understanding the invention and the concepts contributed by the inventors to further the art, and are not to be construed as limitations to such specifically recited examples and conditions, nor does the organization of such examples in the specification relate to a showing of the superiority or inferiority of the invention. Although one or more embodiments of the present invention have been described in detail, it should be understood that the various changes, substitutions, and alterations could be made hereto without departing from the spirit and scope of the invention.

What is claimed is:

1. A method of forming a surface covering, comprising:
supplying a surface covering raw material, the surface covering raw material including a substrate and a foamable layer formed on the substrate; and
applying a foaming inhibiting composition in a predetermined pattern to the foamable layer formed on the substrate,
wherein the foaming inhibiting composition is a non-aqueous composition.

2. The method according to claim 1, wherein a content of water in the foaming inhibiting composition is less than 1% by weight.

3. The method according to claim 1, wherein the supplying of the surface covering raw material includes supplying the substrate and applying the foamable layer to the substrate.

4. The method according to claim 1, wherein the foaming inhibiting composition is applied in the predetermined pattern to the foamable layer using inkjet printing.

5. The method according to claim 4, wherein the inkjet printing is conducted using an inkjet printing apparatus including a drum, an axis of rotation of the drum being orientated at right angles to a direction of feed of the surface covering raw material in sheet form, the surface covering raw material being wound around the drum.

6. The method according to claim 4, wherein the inkjet printing is conducted using an inkjet printing apparatus including a drum, a foaming inhibiting composition applying inkjet printing head configured to apply the foaming inhibiting composition, and at least one inkjet printing head for forming a visible image mounted adjacent to the drum, wherein the foaming inhibiting composition applying inkjet printing head is located upstream of the at least one visible image inkjet printing head in a direction of feed of the surface covering raw material in sheet form.

7. The method according to claim 1, wherein the surface covering raw material is heated while the foaming inhibiting composition is applied.

8. The method according to claim 1, wherein the foamable layer of the surface covering raw material includes a resin material, a foaming agent, a plasticizer and an accelerator.

9. The method according to claim 8, wherein the resin material of the foamable layer of the surface covering raw material includes PVC resin, the foaming agent includes azodicarbonamide, the plasticizer includes dibutyl phthalate and the accelerator includes zinc stearate.

10. The method according to claim 1, wherein the foaming inhibiting composition includes a foaming inhibitor.

11. The method according to claim 10, wherein the foaming inhibiting composition further includes at least one of a diluent and a colorant.

12. The method according to claim 11, wherein the diluent is a plasticizer or an oily component.

13. The method according to claim 10, wherein the foaming inhibitor of the foaming inhibiting composition is selected from benzotriazole derivatives and tolutriazole derivatives.

14. The method according to claim 1, wherein the foaming inhibiting composition includes less than 1% by weight of a volatile organic compound solvent.

15. The method according to claim 1, wherein the foaming inhibiting composition includes a component selected from phthalic acid ester, adipic acid ester, and citric acid ester as a diluent.

16. The method according to claim 1, wherein the foaming inhibiting composition includes a foaming inhibitor and a plasticizer, and the foamable layer of the surface covering raw material includes a resin material, a foaming agent, a plasticizer and an accelerator, at least part of the plasticizer of the foaming inhibiting composition being same as the plasticizer of the foamable layer of the surface covering raw material.

17. The method according to claim 1, further comprising:
foaming the surface covering raw material.

18. The method according to claim 1, further comprising:
foaming the foamable layer after application of the foaming inhibiting composition.

19. An apparatus for forming a surface covering, the apparatus comprising:
a supply unit configured to supply a surface covering raw material, the surface covering raw material including a substrate and a foamable layer formed on the substrate; and
an applicator configured to apply a foaming inhibiting composition in a predetermined pattern to the foamable layer formed on the substrate,
wherein the foaming inhibiting composition is a non-aqueous composition.

20. A foaming inhibiting composition for application to a surface covering raw material in a method of forming a surface covering, the foaming inhibiting composition being a non-aqueous composition and including less than 1% by weight of a volatile organic compound solvent.
